(19) United States
(12) Patent Application Publication
(10) Pub. No.: US 2014/0240956 A1
(43) Pub. Date: Aug. 28, 2014

(54) LIGHT SOURCE DEVICE

(71) Applicant: OLYMPUS CORPORATION, Tokyo (JP)

(72) Inventors: Masahiro NISHIO, Hachioji-shi (JP); Takeshi ITO, Hino-shi (JP)

(73) Assignee: OLYMPUS CORPORATION, Tokyo (JP)

(21) Appl. No.: 14/269,604

(22) Filed: May 5, 2014

Related U.S. Application Data
(63) Continuation of application No. PCT/JP2012/077896, filed on Oct. 29, 2012.

(30) Foreign Application Priority Data
Nov. 7, 2011 (JP) 2011-243207

(51) Int. Cl. F21V 9/00; F21V 29/00

(52) U.S. Cl. CPC F21V 9/00; F21V 29/30; F21V 29/004
USPC 362/84

(57) ABSTRACT

A light source device includes a light conversion unit, a heat radiation unit, and a heat storage unit. The light conversion unit emits illumination light. The heat radiation unit radiates heat generated in the light conversion unit. The heat storage unit is thermally connected to the light conversion unit or the heat radiation unit, and stores the heat.

### CROSS-REFERENCE TO RELATED APPLICATIONS

This application is a Continuation application of PCT Application No. PCT/JP2012/077896, filed Oct. 29, 2012 and based upon and claiming the benefit of priority from prior Japanese Patent Application No. 2011-243207, filed Nov. 7, 2011, the entire contents of all of which are incorporated herein by reference.

### BACKGROUND OF THE INVENTION

1. Field of the Invention

The present invention relates to a light source device.

2. Description of the Related Art

In general, there is known a light source device that emits primary light from a primary light source, leads this primary light to a light conversion unit through an optical fiber, converts characteristics of the primary light in this light conversion unit, and emits the converted light therefrom as illumination light. For example, Jpn. Pat. Appln. KOKAI Publication No. 2007-220326 discloses a technology concerning a light source device including an excitation light source which is a primary light source that emits excitation light as primary light and a fluorescent material as a light conversion unit. In the light source device disclosed in Jpn. Pat. Appln. KOKAI Publication No. 2007-220326, the excitation light emitted from the excitation light source is led through an optical fiber and enters the fluorescent material. A wave length of the led excitation light is converted, and the fluorescent material radiates fluorescence. This light source device emits the radiated fluorescence and the excitation light led from the excitation light source as the illumination light.

In the above-described light source device, heat is generated in the light conversion unit with the light conversion. To stably operate the light source device, the generated heat needs to be removed from the light conversion unit. In this case, the light conversion unit should be appropriately cooled so that a surface temperature of the light source device will not reach a high temperature beyond an allowable temperature that is set in accordance with the device.

### BRIEF SUMMARY OF THE INVENTION

It is an object of the present invention to provide a light source device having a mechanism that cools a light conversion unit while setting a surface temperature of an in-use device to an allowable temperature or less.

According to an aspect of the present invention, a light source device includes: a light conversion unit configured to emit illumination light; a heat radiation unit configured to radiate heat generated in the light conversion unit; and a heat storage unit which is thermally connected to the light conversion unit or the heat radiation unit and configured to store the heat.

According to the present invention, it is possible to provide the light source device that can cool the light conversion unit while setting a surface temperature of an in-use device to an allowable temperature or less since the heat storage unit that stores heat is provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an outline of a configuration example of a light source device according to a first embodiment of the present invention;

FIG. 2A is a perspective view for explaining an outline of a configuration example of a distal end portion of the light source device according to the first embodiment;

FIG. 2B is a schematic view of a cross section for explaining the outline of the configuration example of the distal end portion of the light source device according to the first embodiment;

FIG. 3 is a view for explaining an outline of another configuration example of the distal end portion of the light source device according to the first embodiment;

FIG. 4 is a view for explaining an outline of an example of a relationship between an elapsed time from start of an operation and a surface temperature of a heat radiation member concerning the light source device according to the first embodiment;

FIG. 5 is a view showing an outline of a configuration example of a light source device according to a first modification of the first embodiment;

FIG. 6 is a view showing an outline of a configuration example of a light source device according to a second embodiment;

FIG. 7 is a view showing an outline of a configuration example of a light source device according to a first modification of the second embodiment;

FIG. 8 is a view for explaining an outline of an example of a relationship between an elapsed time from start of an operation and a surface temperature of a heat radiation member concerning the light source device according to the second embodiment, and is a view of a situation that a first heat storage member and a second heat storage member have the same configuration;

FIG. 9 is a view for explaining an outline of an example of a relationship between an elapsed time from start of an operation and a surface temperature of the heat radiation member concerning the light source device according to the second embodiment, and is a view of a situation that configurations of the first heat storage member and the second heat storage member are appropriately set;

FIG. 10A is a view showing an outline of a configuration example of a light source device according to a third embodiment, and is a view showing a state that the light source device is extended;

FIG. 10B is a view showing an outline of the configuration example of the light source device according to the third embodiment, and is a view showing a state that the light source device is bent;

FIG. 11A is a view showing an outline of a configuration example of a light source device according to a first modification of the third embodiment, and is a view showing a state that the light source device is extended;

FIG. 11B is a view showing an outline of the configuration example of the light source device according to the first modification of the third embodiment, and is a view showing a state that the light source device is bent; and

FIG. 12 is a view showing an outline of a configuration example of a light source device according to a second modification of the third embodiment.

### DETAILED DESCRIPTION OF THE INVENTION

### First Embodiment

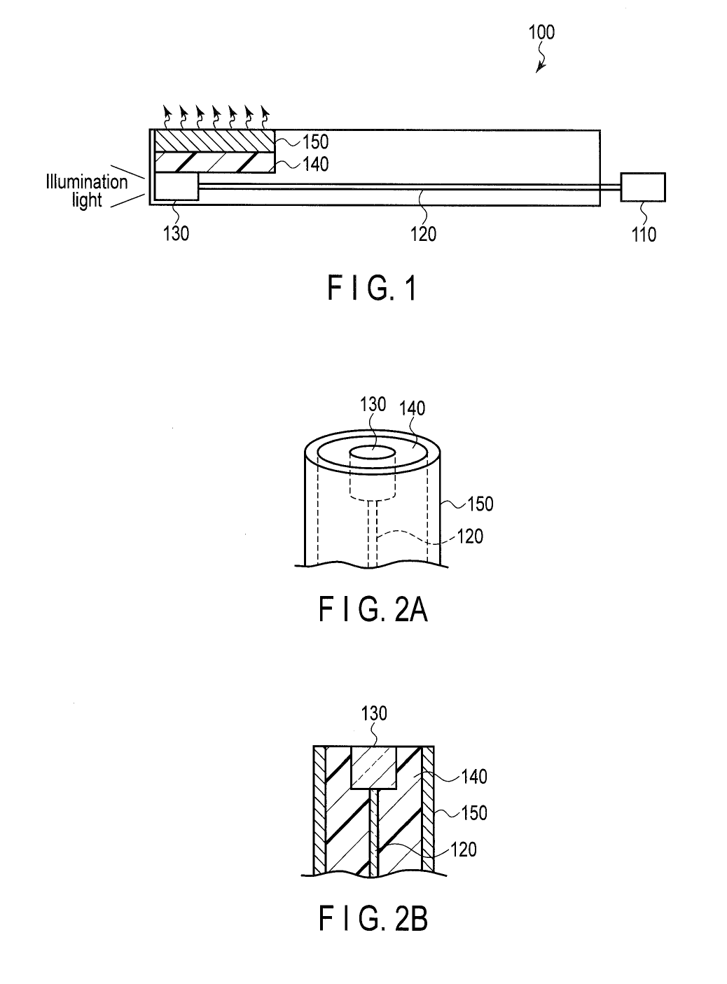

A first embodiment according to the present invention will now be described with reference to the drawings. FIG. 1 shows an outline of a configuration of a light source device 100 according to this embodiment. The light source device 100 includes a primary light source 110, an optical fiber 120, a light conversion element 130, a heat storage member 140, and a heat radiation member 150.

The primary light source 110 emits primary light. As the primary light, it is possible to use various kinds of light in accordance with the later-described light conversion element 130. The primary light emitted from the primary light source 110 is led toward the light conversion element 130 through the optical fiber 120. That is, the optical fiber 120 is connected to the primary light source 110 and the light conversion element 130.

The light conversion element 130 receives the primary light led through the optical fiber 120 and emits secondary light as illumination light emitted from the light source device 100. For example, the light conversion element 130 may include a fluorescent material that generates florescence using the primary light as excitation light. Furthermore, for example, the light conversion element 130 may include an element having a light diffusing function of enlarging a spread angle of the primary light and emitting this light as safe secondary light, when the primary light is a laser beam. Moreover, for example, when the primary light is a laser beam, the light conversion element 130 may include an element having a function of converting a phase of the laser beam to reduce coherence and avoid generation of speckles.

The heat storage member 140 has a heat storing function. For example, the heat storage member 140 may include a sensible heat storage member using water, a metal having high specific heat, or the like. Additionally, the heat storage member 140 may include a latent heat storage material using endotherm at the time of a phase change. In particular, the heat storage member 140 may include heat storage capsules or the like obtained by forming microcapsules of the latent heat storage material. The heat storage capsule has a structure in which the latent heat storage material such as an aliphatic hydrocarbon compound, alcohol, ester, or an aliphatic acid is contained in a resin film having a diameter of, e.g., several μm. The heat storage member 140 is thermally connected to the light conversion element 130 and the heat radiation member 150. Therefore, the heat storage member 140 stores part of the heat generated by the light conversion element 130 and transfers that heat to the heat radiation member 150.

The heat radiation member 150 is a member that radiates heat to an exterior environment from the light source device 100. The heat generated by the light conversion element 130 is transferred to the heat radiation member 150 via the heat storage member 140 and radiated from the heat radiation member 150. The exterior or the like of the light source device 100 may be allowed to function as the heat radiation member 150. It is to be noted that, in FIG. 1, arrows directed toward the outside of the device from the heat radiation member 150 schematically represent that the heat is radiated from the heat radiation member 150 to the outside of the light source device 100.

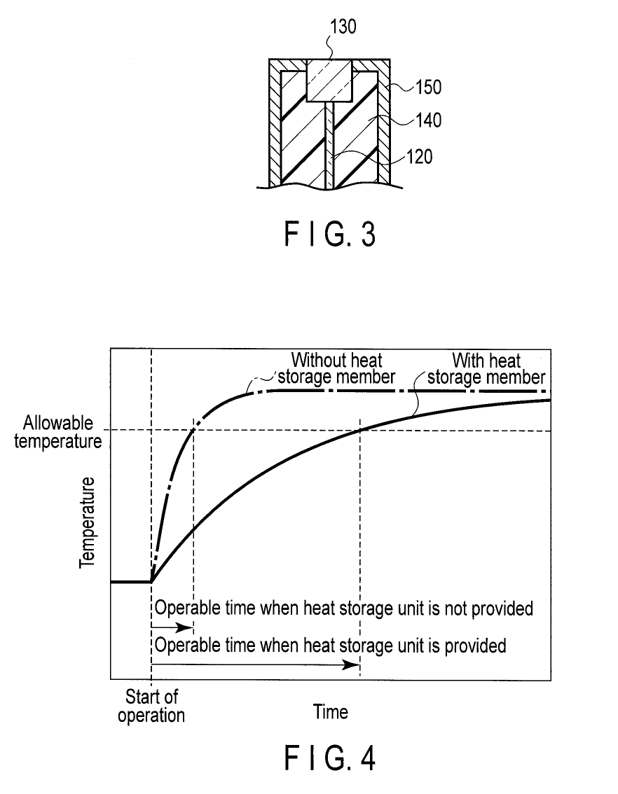

FIG. 2A and FIG. 2B show an example of a configuration of a distal end portion of the light source device 100 in which the heat storage member 140 and the heat radiation member 150 are arranged. FIG. 2A is a perspective view schematically showing an outline of the distal end portion of the light source device 100, and FIG. 2B is a schematic view showing an outline of a cross section of the distal end portion. In this embodiment, the distal end portion in which the light conversion element 130 of the light source device 100 is arranged has a cylindrical shape. In the light source device 100, the exterior functions as the heat radiation member 150. Therefore, the heat radiation member 150 has a hollow cylindrical shape. The light conversion element 130 is arranged near the center of an end portion of the heat radiation member 150. The optical fiber 120 connected to the light conversion element 130 is arranged along a central axis of the heat radiation member 150. In this embodiment, a space in the heat radiation member 150, which is a region excluding structures, e.g., the light conversion element 130 and the optical fiber 120, is filled with the heat storage member 140. It is to be noted that, as shown in FIG. 3, a configuration that part of the heat radiation member 150 which is the exterior is in contact with the light conversion element 130 may be adopted.

An operation of the light source device 100 according to this embodiment will now be described. For example, the primary light source 110 is assumed to be a laser beam source that emits a laser beam. The primary light source 110 emits a laser beam as primary light. The emitted laser beam enters the optical fiber 120. This laser beam travels in the optical fiber 120 and reaches the light conversion element 130.

For example, the light conversion element 130 is assumed to contain a fluorescent material that absorbs the laser beam, which is the primary light, as excitation light and generates fluorescence. In this case, the light conversion element 130 absorbs the laser beam led through the optical fiber 120 and radiates the excitation light. That is, the wavelength of the laser beam is converted by the light conversion element 130. The fluorescence that was subjected to this wavelength conversion and the excitation light that was not subjected to the wavelength conversion are allowed to exit from the distal end of the light source device 100 as illumination light.

The light conversion element 130 generates heat at the time of performing the wavelength conversion. The heat generated from this light conversion element 130 is transferred to the heat storage member 140. The heat storage member 140 stores part of the heat transferred from the light conversion element 130. When the heat storage member 140 includes a sensible heat storage material such as water or a metal having high specific heat, part of the heat is stored in the sensible heat storage material as sensible heat. Further, when the heat storage member 140 includes heat storage capsules, part of the heat is absorbed by the heat storage capsules as latent heat. The heat that is not stored in the heat storage member 140 is transferred to the heat radiation member 150. The heat radiation member 150 having the heat transferred from the heat storage member 140 discharges part of the heat to the outside of the light source device 100.

As described above, for example, the light conversion element 130 functions as a light conversion unit that emits the illumination light. For example, the heat radiation member 150 functions as a heat radiation unit that radiates heat generated in the light conversion unit to the outside. For example, the heat storage member 140 functions as a heat storage unit that is thermally connected to the light conversion unit or the heat radiation unit and stores heat.

To explain the effect of this embodiment, FIG. 4 shows a change in temperature relative to an elapsed time. In this drawing, a solid line represents a change in temperature on a peripheral surface of a distal end portion of the light source device 100 according to this embodiment, i.e., a change in temperature of the heat radiation member 150 when the heat storage member 140 is provided. On the other hand, a dashed-dotted line represents a change in temperature in a comparative example. In this comparative example, there is shown a change in temperature when the same configuration as that in this embodiment is provided but the heat storage member is not provided, i.e., when the portion of the heat storage member 140 in this embodiment is filled with, e.g., a material having low specific heat that is the same as the heat radiation member 150. As shown in FIG. 4, a surface temperature of the light source device slowly increases as compared with the comparative example having no heat storage member 140 since the heat is transferred to the heat radiation member 150 while the heat storage member 140 absorbs the heat in this embodiment.

For example, to avoid damage to the light source device 100 and/or safely use the light source device 100, the need for providing an allowable limit to the surface temperature is assumed. This allowable temperature is indicated by a broken line in FIG. 4. Assuming that the light source device 100 can be used just before exceeding the allowable temperature, as is obvious from this drawing, an operable time in this embodiment having the heat storage member 140 is much longer than an operable time in the comparative example having no heat storage member. When a heat capacity of the heat storage member 140 is set to be larger than a value that is determined based on (the amount of heat generation in a light emitting element)×(an operating time required by the light source device), the light source device 100 can be used without exceeding the required operating time and the allowable temperature.

When the allowable temperature is set to a temperature at which a failure or deterioration in each unit is not caused or a temperature at which discomfort or the like is not given to a user, it is possible to avoid a failure of the device or prevent discomfort from being given to a user. It is to be noted that, in the case of using a latent heat storage material for the heat storage member 140, when a heat storage temperature of the latent heat storage material is set to be lower than the allowable temperature, the effect can be obtained in particular.

In this embodiment, the heat storage member 140 is installed between the heat radiation member 150 and the light conversion element 130, but it may be installed in any region as long as heat from the light conversion element 130 can be transferred to this region. Additionally, the heat storage member 140 may be incorporated in the heat radiation member 150. Further, the heat radiation member 150 may be made of a material having relatively high specific heat. Furthermore, it is possible to adopt a configuration that heat is discharged from the heat storage member 140 to the outside of the light source device 100 without providing the heat radiation member 150. In any case, the same effect as that described above can be obtained.

[First Modification of First Embodiment]

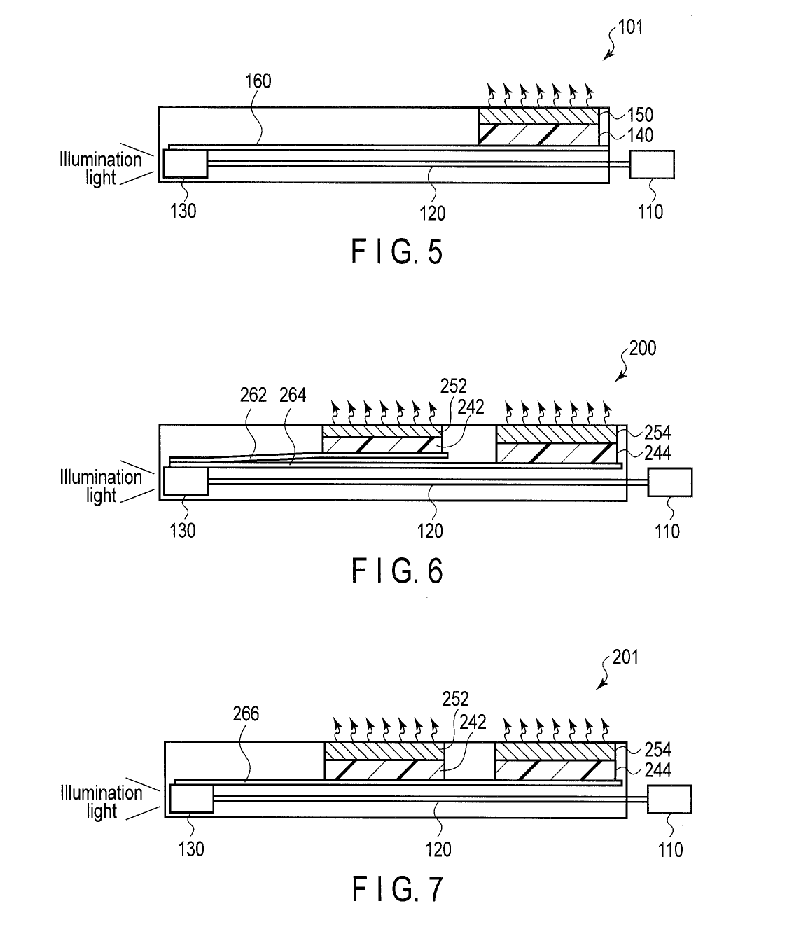

A first modification of the first embodiment will now be described. Here, a difference from the first embodiment will be explained, and like reference numerals denote like parts to omit a description thereof. FIG. 5 is a schematic view showing a configuration example of a light source device 101 according to this modification. As shown in this drawing, the light source device 101 according to this modification includes a heat transfer member 160 additionally provided to the light source device 100 according to the first embodiment. The heat transfer member 160 is made of a material having high thermal conductivity, and it has low thermal resistance, i.e., readily transfers heat. The heat transfer member 160 is formed by using a graphite sheet or a metal having high thermal conductivity such as copper. Moreover, the heat transfer member 160 is formed by using a heat pipe.

The heat transfer member 160 is interposed between a light conversion element 130 and a heat storage member 140. In the example shown in FIG. 5, the light conversion element 130 is arranged on a distal end side of the light source device 101, and the heat storage member 140 and a heat radiation member 150 are arranged on a proximal end side. The heat transfer member 160 is arranged between the light conversion element 130 and the heat storage member 140.

In this modification, heat generated by the light conversion element 130 at the distal end portion of the light source device 101 is transferred to the heat storage member 140 at the proximal end portion of the light source device 101 through the heat transfer member 160. Like the first embodiment, part of the heat transferred to the heat storage member 140 is stored in the heat storage member 140, and part of the heat is transferred to the heat radiation member 150 and radiated from the heat radiation member 150.

According to this modification, the heat storage member 140 and the heat radiation member 150 can be arranged at positions apart from the light conversion element 130. For example, in the light source device used for illuminating a narrow space, reducing a size of an illumination light emitting portion may be demanded. In such a case, according to this modification, the heat storage member 140 or the heat radiation member 150 that is relatively large can be arranged at a position apart from the distal end portion at which the light conversion element 130 required to be miniaturized is arranged. As a result, an increase in temperature of the distal end portion of the light source device 101 can be further suppressed. Additionally, the light source device 101 according to this modification exercises an effect relative to use in a situation where radiating heat to the outside of the device is difficult at the distal end portion of the light source device 101.

As described above, for example, the heat transfer member 160 functions as a heat transfer unit that transfers heat generated in the light conversion unit to the heat radiation unit or the heat storage unit. It is to be noted that heat radiation from the heat transfer member 160 may be effectively used by increasing a length of the heat transfer member 160. That is, the heat transfer member 160 may be configured to function as the heat radiation member 150. Further, in this modification, the heat storage member 140 is arranged in contact with the heat radiation member 150 on the heat radiation member 150 side, but the heat storage member 140 may be arranged in contact with the light conversion element 130 on the light conversion element 130 side, and this heat storage member 140 and the heat radiation member 150 may be thermally connected through the heat transfer member 160.

### Second Embodiment

A second embodiment will now be described. A difference from the first modification of the first embodiment will be explained, and like reference numerals denote like parts to omit a description thereof. FIG. 6 shows an outline of a configuration example of a light source device 200 according to this embodiment. As shown in this drawing, the light source device 200 according to this embodiment includes a first heat storage member 242 and a second heat storage member 244 that have the same configuration and function in the same manner as the heat storage member 140. Further, the light source device 200 includes a first heat radiation member 252 and a second heat radiation member 254 that have the same configuration and function in the same manner as the heat radiation member 150. The first heat storage member 242 and the first heat radiation member 252 are in contact and thermally connected with each other, and they are arranged apart from a light conversion element 130. Likewise, the second heat storage member 244 and the second heat radiation member 254 are in contact and thermally connected to each other. The second heat storage member 244 and the second heat radiation member 254 are arranged apart from the light conversion element 130, the first heat storage member 242, and the first heat radiation member 252. Here, the first heat radiation member 252 and the second heat radiation member 254 have an equivalent heat radiation capability, i.e., equivalent thermal conductance (easiness in transferring heat) to an external atmosphere of the light source device 200.

The light conversion element 130 and the first heat storage member 242 are thermally connected through a first heat transfer member 262 that has the same configuration and functions in the same manner as the heat transfer member 160. Likewise, the light conversion element 130 and the second heat storage member 244 are thermally connected through a second heat transfer member 264 that has the same configuration and functions in the same manner as the heat transfer member 160.

A distance between the light conversion element 130 and the first heat storage member 242 is different from a distance between the light conversion element 130 and the second heat storage member 244. That is, length of the first heat transfer member 262 and that of the second heat transfer member 264 are different from each other. In this embodiment, the first heat radiation member 252 is arranged to be closer to the light conversion element 130 than the second heat radiation member 254, and the first heat transfer member 262 is shorter than the second heat transfer member 264. Therefore, if the first heat transfer member 262 and the second heat transfer member 264 are formed into the same configuration by using the same material, the first heat transfer member 262 has higher thermal conductance. Thus, in this embodiment, the first heat transfer member 262 and the second heat transfer member 264 have materials and/or configurations different from each other, and the first heat transfer member 262 and the second heat transfer member 264 have the same thermal conductance. For example, when the second heat transfer member 264 has a thickness and/or a width larger than the first heat transfer member 262, the first heat transfer member 262 and the second heat transfer member 264 are adjusted to have the same thermal conductance. Furthermore, both the first heat transfer member and the second heat transfer member may be made of a graphite sheet as the same material or made of different materials. Even if different materials are used, the thermal conductance can be adjusted.

When the thermal conductance is adjusted as described above, quantities of heat that are transferred to the first heat radiation member 252 and the second heat radiation member 254 and radiated from the same become equal to each other. As a result, the first heat radiation member 252 and the second heat radiation member 254 have the same surface temperature.

In this embodiment, when the heat radiation members, i.e., the first heat radiation member 252 and the second heat radiation member 254 are provided, heat generated by the light conversion element 130 can be dispersed to such members. As a result, the light source device 200 can be prevented from locally having a high temperature.

In this embodiment, although the first heat radiation member 252 and the second heat radiation member 254 have the equivalent heat radiation capability, when there is a difference between their heat radiation capabilities, setting the thermal conductance of the first heat transfer member 262 and that of the second heat transfer member 264 to be proportionate to a ratio of inverse numbers of the thermal conductance of the first heat radiation member 252 and that of the second heat radiation member 254 enables equalizing temperatures of the first heat radiation member 252 and the second heat radiation member 254. Further, in this embodiment, the description refers to the example where the number of each of the heat transfer members, the heat storage members, and the heat radiation members is two, but this number may be three or more as a matter of course.

Furthermore, in this embodiment, the light conversion element 130 and the first heat storage member 242 are thermally connected through the first heat transfer member 262, and the light conversion element 130 and the second heat storage member 244 are thermally connected through the second heat transfer member 264, but one of the first heat storage member 242 and the second heat storage member 244 may be thermally directly connected to the light conversion element 130.

[First Modification of Second Embodiment]

A first modification of the second embodiment will now be described. Here, a difference from the second embodiment will be explained, and like reference numerals denote like parts to omit a description thereof. FIG. 7 shows an outline of a configuration of a light source device 201 according to this modification. As shown in this drawing, in this modification, one heat transfer member 266 is provided in place of the first heat transfer member 262 and the second heat transfer member 264 in the light source device 201.

A first heat storage member 242 and a second heat storage member 244 are thermally connected to the heat transfer member 266. A first heat radiation member 252 is thermally connected to the first heat storage member 242, and a second heat radiation member 254 is thermally connected to the second heat storage member 244. The first heat radiation member 252 and the first heat storage member 242 are arranged to be closer to a light conversion element 130 than the second heat radiation member 254 and the second heat storage member 244. Therefore, thermal resistance from the light conversion element 130 to the first heat storage member 242 is lower than thermal resistance from the light conversion element 130 to the second heat storage member 244.

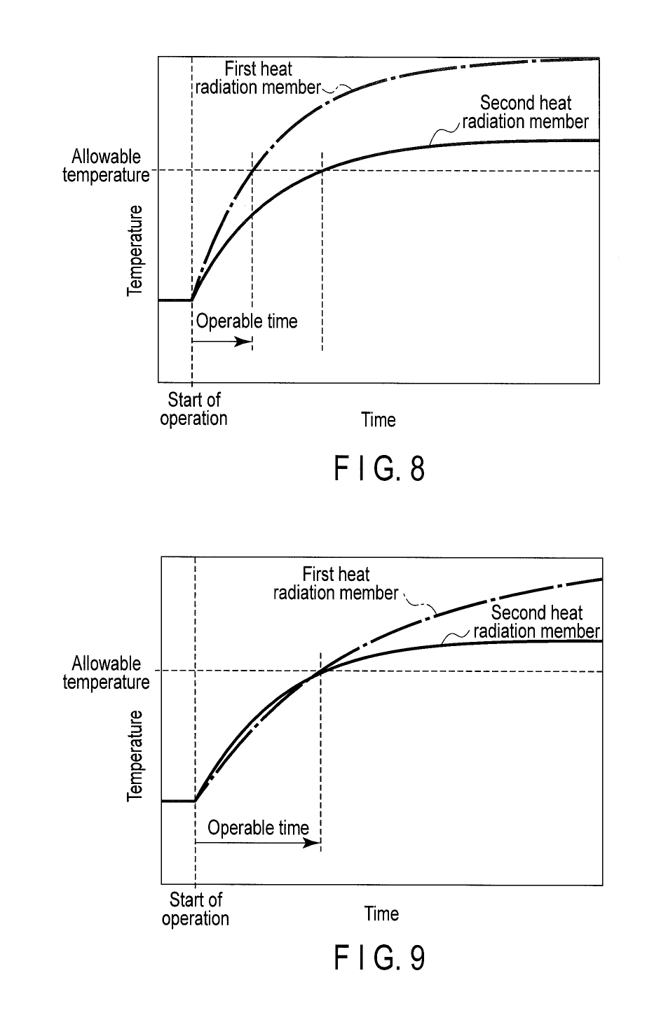

Based on the above description, when configurations of the first heat storage member 242 and the first heat radiation member 252 are set to be equal to configurations of the second heat storage member 244 and the second heat radiation member 254, changes in temperature of these members are as shown in FIG. 8. In FIG. 8, a dashed-dotted line represents a change in surface temperature of the first heat radiation member 252 with time, and a solid line represents a change in surface temperature of the second heat radiation member 254 with time. As shown in this drawing, a surface temperature of the first heat radiation member 252 is higher than a surface temperature of the second heat radiation member 254. That is, the first heat radiation member 252 has a shorter operating time, during which its temperature is lower than an allowable temperature, than the second heat radiation member 254. Thus, in this modification, heat capacity of the first heat storage member 242 is higher than that of the second heat storage member 244, resulting in that the surface temperature of the first heat radiation member 252 is set to be substantially equal to that of the second heat radiation member 254 during a predetermined period as shown in FIG. 9. When the setting is configured in this manner, an operable time of the light source device 201 is set to be longer than that shown in FIG. 8.

According to this modification, in a state that heat radiation efficiencies of the first heat radiation member 252 and the second heat radiation member 254 and the thermal conductance of the heat transfer member 266 are increased as much as possible, the thermal capacities of the first heat storage member 242 and the second heat storage member 244 can be set in accordance with the heat radiation efficiencies of the first heat radiation member 252 and the second heat radiation member 254, and the surface temperatures of the first heat radiation member 252 and the second heat radiation member 254 are allowed to coincide with each other. Therefore, heat generated from the light conversion element 130 can be radiated to the outside of the device without locally increasing a temperature on the surface of the light source device 201.

### Third Embodiment

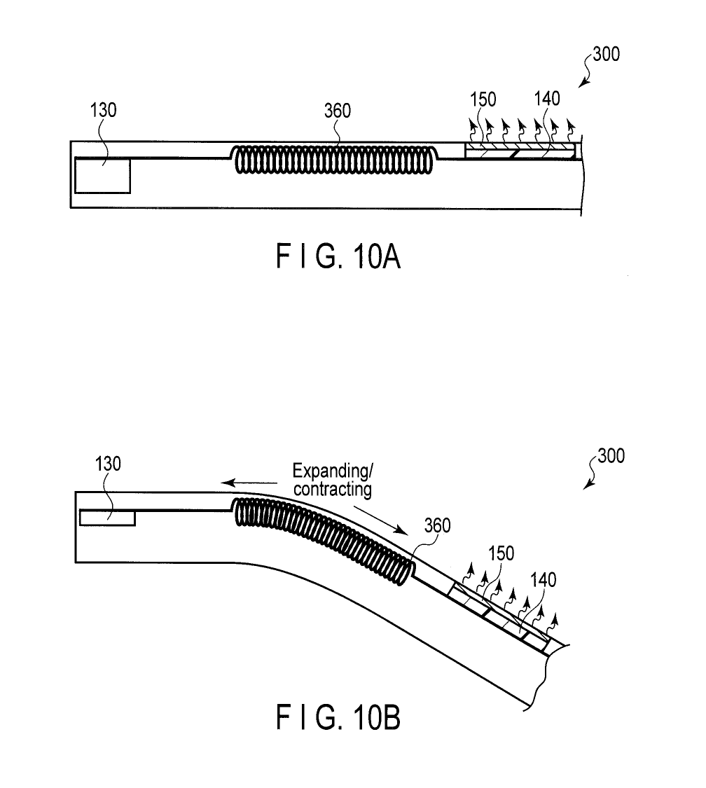

A third embodiment will now be described. A difference from the first modification of the first embodiment will be explained, and like reference numerals denote like parts to omit a description thereof. A light source device 300 according to this embodiment is a light source device in which a portion between a distal end portion at which a light conversion element 130 is arranged and a proximal end portion at which a primary light source 110 is arranged is bent. FIG. 10A and FIG. 10B show an outline of a configuration of the light source device 300 according to this embodiment. In these drawings, the primary light source 110 and an optical fiber 120 are omitted. FIG. 10A shows a state in which the light source device 300 is extended, and FIG. 10B shows a state in which the light source device 300 is bent.

As shown in FIG. 10A and FIG. 10B, in the light source device 300 according to this embodiment, a light conversion element 130 is arranged on a distal end side, and a heat storage member 140 and a heat radiation member 150 are arranged at positions apart from the light conversion element 130. The light conversion element 130 and the heat storage member 140 are thermally connected through a heat transfer member 360. Here, the heat transfer member 360 is formed of, e.g., a graphite sheet. Part of the heat transfer member 360 has a helical (spring-like) shape and can be elongated and contracted. That is, part of the heat transfer member 360 can be bent.

When the light source device 300 is bent, an elongating or contracting force is applied to the heat transfer member 360. Here, since the heat transfer member 360 has a helical shape and is deformable, stress can be prevented from being locally concentrated on the heat transfer member 360. As a result, in the light source device 300 according to this embodiment, the heat transfer member 360 can be bent without being fractured.

It is to be noted that the shape of the heat transfer member 360 is not restricted to the helical shape. For example, it is possible to adopt any shape, e.g., a zigzag shape as long as it has a shape in which the heat transfer member can elongate and contract as a whole. In the description with reference to FIG. 10A and FIG. 10B, the example where the light source device 300 is bent in one direction has been described, and a configuration that the light source device 300 deforms to be twisted or bends in two axis directions can be adopted.

[First Modification of Third Embodiment]

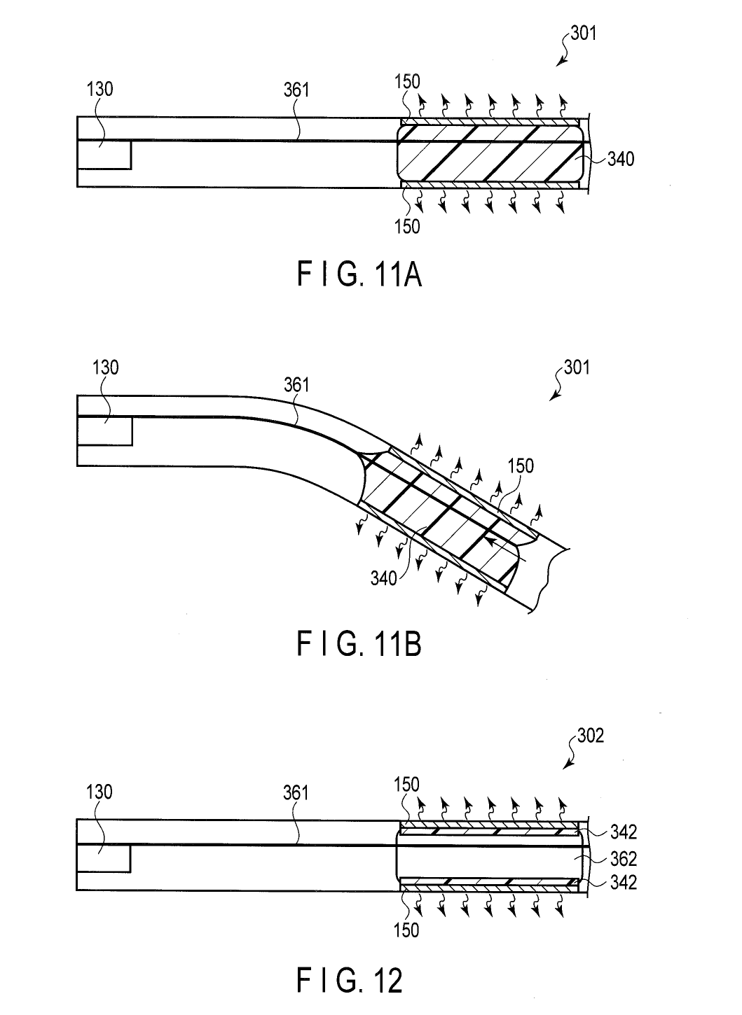

A first modification of the third embodiment will now be described. A difference from the third embodiment will be explained, and like reference numerals denote like parts to omit a description thereof. FIG. 11A and FIG. 11B are schematic views showing a configuration of a light source device 301 according to this modification. FIG. 11A shows a state in which the light source device 301 is extended, and FIG. 11B shows a state in which the light source device 301 is bent. In this modification, a heat storage member 340 is made of a gel-like material. Furthermore, in place of the heat transfer member 360 according to the third embodiment, a heat transfer member 361 that has a linear or ribbon-like straight-line shape and has no elongating/contracting function is provided in this embodiment.

In this embodiment, a heat radiation member 150 is arranged at a position on a proximal end side apart from a light conversion element 130 to surround a peripheral surface of the light source device 300. A heat transfer member 361 connected to the light conversion element 130 is inserted in the light source device 301 until it reaches a region where the heat radiation member 150 is arranged. A portion between the heat transfer member 361 and the heat radiation member 150 is filled with the gel-like heat storage member 340. The gel-like heat storage member 340 deforms when a force is applied thereto.

When the light source device 301 is bent, a force is applied to the heat transfer member 361 along a longitudinal direction thereof. When the force is applied to the heat transfer member 361 by bending in this manner, the gel-like heat storage member 340 deforms, and hence a position of the heat transfer member 361 shifts as shown in FIG. 11B. When the gel-like heat storage member 340 deforms and the position of the heat transfer member 361 shifts in this manner, stress can be prevented from being locally concentrated on the heat transfer member 361. Therefore, it is possible to configure an indestructible and bendable light source device 301 without fracturing the heat transfer member 361.

It is to be noted that, when the heat storage member 340 may include a fluid such as water, air, and a slurry liquid having heat storage capsules dispersed therein, and others besides the gel-like heat storage material and the heat transfer member 361 is thermally connected to the heat radiation member 150 without mechanically fixing the heat transfer member 361, the same effect can be obtained.

[Second Modification of Third Embodiment]

A second embodiment of the third embodiment will now be described. Here, a difference from the first modification of the third embodiment will be explained, and like reference numerals denote like parts to omit a description thereof. FIG. 12 shows an outline of a configuration of a light source device 302 according to this modification. In this modification, a heat storage member 342 is arranged on an inner surface of a heat radiation member 150, and a gel-like heat transfer member 362 is arranged between this heat storage member 342 and the heat transfer member 361. Moreover, like the first modification of the third embodiment, the heat transfer member 361 has a linear or ribbon-like straight-line shape and does not have an elongating/contracting function.

According to this modification, when the light source device 302 is bent and force is applied to the heat transfer member 361, the gel-like heat transfer member 362 deforms, and stress can be prevented from being locally concentrated on the heat transfer member 361. Therefore, according to this modification, the indestructible and bendable light source device 302 can be likewise configured. As described above, for example, the gel-like heat transfer member 362 functions as a deformation heat transfer member.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light source device comprising:
a light conversion unit configured to emit illumination light;
a heat radiation unit configured to radiate heat generated in the light conversion unit; and
a heat storage unit which is thermally connected to the light conversion unit or the heat radiation unit and configured to store the heat.

2. The device according to claim 1,
wherein the light conversion unit and the heat radiation unit are provided to be apart from each other, and
the device further comprises a heat transfer unit configured to transfer the heat generated in the light conversion unit to the heat radiation unit or the heat storage unit.

3. The device according to claim 1, wherein the heat storage unit includes a latent heat storage material.

4. The device according to claim 1, wherein the heat storage unit includes water.

5. The device according to claim 1, wherein the heat storage unit functions as the heat radiation unit.

6. The device according to claim 2, wherein the heat storage unit includes a latent heat storage material.

7. The device according to claim 2, wherein the heat storage unit includes water.

8. The device according to claim 2, wherein the heat storage unit functions as the heat radiation unit.

9. The device according to claim 2, wherein
the heat radiation unit includes a first heat radiation member and a second heat radiation member,
the first heat radiation member and/or the second heat radiation member is thermally connected to the light conversion unit via the heat transfer unit, and
heat characteristics of the first heat radiation member, the second heat radiation member, the heat transfer unit, and the heat storage unit are set in such a manner that a surface temperature of the first heat radiation member coincides with a surface temperature of the second heat radiation member.

10. The device according to claim 9, wherein
the heat transfer unit includes a first heat transfer member and a second heat transfer member,
the first heat radiation member is thermally connected to the light conversion unit via the first heat transfer member,
the second heat radiation member is thermally connected to the light conversion unit via the second heat transfer member, and
a thermal conductance of the first heat transfer member and a thermal conductance of the second heat transfer member are set in such a manner that a ratio of a quantity of heat transferred to the first heat radiation member and a quantity of heat transferred to the second heat radiation member has a predetermined value.

11. The device according to claim 2, wherein
the heat radiation unit includes a first heat radiation member and a second heat radiation member,
the heat storage unit includes a first heat storage member and a second heat storage member,
the first heat radiation member is thermally connected to the first heat storage member,
the second heat radiation member is thermally connected to the second heat storage member,
the first heat storage member and/or the second heat storage member is thermally connected to the light conversion unit via the heat transfer unit, and
a heat capacity of the first heat storage member and a heat capacity of the second heat storage member are set in such a manner that a time required until a surface temperature of the first heat radiation member reaches a predetermined value, after allowing the light conversion unit to function, becomes equal to a time required until a surface temperature of the second heat radiation member reaches a predetermined value, after the allowing the light conversion unit to function, in accordance with a heat radiation capability of the first heat radiation member and a heat radiation capability of the second heat radiation member.

12. The device according to claim 2, wherein the heat transfer unit functions as the heat radiation unit.

13. The device according to claim 2, wherein the device is configured to be bent between a portion at which the light conversion unit is placed and a portion at which the heat radiation unit is placed.

14. The device according to claim 13, wherein length of the heat transfer unit changes when the device is bent.

15. The device according to claim 13, wherein the heat transfer unit is twisted when the device is bent.

16. The device according to claim 13, wherein
the heat transfer unit and the heat radiation unit are not mechanically fixed, and
the heat transfer unit and the heat radiation unit are thermally connected via a fluid.

17. The device according to claim 13, wherein
the heat storage unit is deformable, and
the heat transfer unit and the heat radiation unit are thermally connected via the deformable heat storage unit.

18. The device according to claim 13, further comprising a deformable heat transfer member,
wherein the heat transfer unit and the heat radiation unit are thermally connected via the deformable heat transfer member.
